(19) United States
(12) Patent Application Publication
(10) Pub. No.: US 2012/0282932 A1
(43) Pub. Date: Nov. 8, 2012

(54) Apparatus and Method

(75) Inventors: Ling Yu, Oulu (FI); Vinh Van Phan, Oulu (FI); Kari Veikko Horneman, Oulu (FI)

(73) Assignee: Nokia Siemens Networks OY, Espoo (FI)

(21) Appl. No.: 13/516,020

(22) PCT Filed: Dec. 16, 2009
(86) PCT No.: PCT/EP09/67232

§ 371 Date: Jul. 16, 2012

(51) Int. Cl. H04W 36/08; H04W 88/00; H04W 36/00; H04B 7/15

(52) U.S. Cl. 455/437; 455/11.1; 455/550.1; 455/436

(57) ABSTRACT

An apparatus and a method are provided. The provided solution includes a communication control circuitry configured to detect on the basis of a predetermined criterion a need to suspend the operation of a mobile relay base station connected to the apparatus, control the mobile relay base station to suspend its operation, control the apparatus to connect to the user equipment performing a handover from the mobile relay base station to the apparatus prior the suspension of the mobile relay base station, detect on the basis of a predetermined criterion a need to resume the operation of the mobile relay base station, and control the mobile relay base station to resume its operation.

### FIELD

The embodiments of the invention relate generally to communication networks and, more particularly, to an apparatus and a method in communication networks.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context. With the ever increasing demand for increasing data rates and higher quality services in the world of mobile communications comes ever increasing demand for better performance of cellular network infrastructures. People use their mobile equipment with support for high data rate services while they are at work, at home, and/or while traveling on a mass transportation vehicle, e.g. bus, train, and ship. Such a mass transportation vehicle may travel at a speed of up to 100 m/s, and a huge number of communicating mobile devices in the vehicle traveling at the same speed sets high demands for network operators, because the users wish to preserve their high data rate connections regardless of the speed of the vehicle. Long-term evolution (LTE) of the 3rd generation mobile communication system standardized within 3GPP (3rd Generation Partnership Project) has introduced a relayed extension to cellular network infrastructure. Relaying links between user terminals and conventional base stations through relaying base stations improves capacity, coverage, and data rates. The relay base stations may be mobile or nomadic, installed in buses, trains and other mass transportation vehicles.

### BRIEF DESCRIPTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

According to an aspect of the present invention, there is provided an apparatus comprising a communication control circuitry configured to detect on the basis of a predetermined criterion a need to suspend the operation of a mobile relay base station connected to the apparatus, control the mobile relay base station to suspend its operation, control the apparatus to connect to the user equipment performing a hand-over from the mobile relay base station to the apparatus prior the suspension of the mobile relay base station, detect on the basis of a predetermined criterion a need to resume the operation of the mobile relay base station, and control the mobile relay base station to resume its operation. According to an aspect of the present invention, there is provided an apparatus comprising a communication control circuitry configured to receive a suspension command from an eNodeB connected to the apparatus, send a handover command to user equipment connected to the apparatus and to be moved to under the eNodeB, suspend the operation of the apparatus, resume the operation of the apparatus if a predetermined criterion is fulfilled, and connect to user equipment performing a handover from the eNodeB to the apparatus.

According to an aspect of the present invention, there is provided an apparatus comprising a communication control circuitry configured to control the apparatus to perform a synchronous handover from a mobile relay base station to an eNodeB when the mobile relay base station the apparatus is connected to is to be suspended temporarily; store user equipment context and mobile relay node context while being connected to the eNodeB; and perform a handover back to the mobile relay base station utilizing the stored contexts if the mobile relay node is detected to resume operation.

According to another aspect of the present invention, there is provided a method comprising detecting on the basis of a predetermined criterion a need to suspend the operation of a mobile relay base station, controlling the mobile relay base station to suspend its operation, connecting to the user equipment performing a handover from the mobile relay base station prior the suspension of the mobile relay base station, detecting on the basis of a predetermined criterion a need to resume the operation of the mobile relay base station, and controlling the mobile relay base station to resume its operation.

According to another aspect of the present invention, there is provided a method comprising receiving a suspension command from an eNodeB, sending a handover command to user equipment connected to the apparatus and to be moved to under the eNodeB, suspending the operation of the apparatus, resuming the operation of the apparatus if a predetermined criterion is fulfilled, and connecting to user equipment performing a handover from the eNodeB to the apparatus.

According to another aspect of the present invention, there is provided a method comprising performing a synchronous handover from a mobile relay base station to an eNodeB when the mobile relay base station is to be suspended temporarily; storing user equipment context and mobile relay node context while being connected to the eNodeB; and performing a handover back to the mobile relay base station utilizing the stored contexts if the mobile relay node is detected to resume operation.

A chipset may comprise the apparatus discussed above. According to another aspect of the present invention, there is provided a computer program comprising program code means adapted to perform the methods discussed above.

According to another aspect of the present invention, there is provided an article of manufacture comprising a computer readable medium and embodying program instructions thereon executable by a computer operably coupled to a memory which, when executed by the computer, perform methods discussed above.

Although the various aspects, embodiments and features of the invention are recited independently, it should be appreciated that all combinations of the various aspects, embodiments and features of the invention are possible and within the scope of the present invention as claimed.

### LIST OF DRAWINGS

Embodiments of the present invention are described below, by way of example only, with reference to the accompanying drawings, in which

FIG. 1 illustrates an example of a communication environment to which embodiments of the invention may be applied;

FIGS. 2A and 2B illustrate an example of spectrum usage;

FIG. 3 illustrates an example of an embodiment;

FIGS. 4A and 4B are flowcharts illustrating some embodiments of the invention.

FIGS. 5A, 5B and 5C illustrate simplified examples of apparatuses; and

FIGS. 6A and 6B are signaling charts illustrating embodiments of the invention.

### DESCRIPTION OF EMBODIMENTS

Exemplary embodiments of the present invention will now be de-scribed more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

Embodiments are applicable to any base station, user equipment, server, corresponding component, and/or to any communication system or any combination of different communication systems that support required functionality.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

In the following, different embodiments will be described using, as an example of a system architecture whereto the embodiments may be applied, an architecture based on Evolved UMTS terrestrial radio access (E-UTRA, UMTS=Universal Mobile Telecommunications System) without restricting the embodiment to such an architecture, however.

Many different radio protocols to be used in communications systems exist. Some examples of different communication systems are the universal mobile telecommunications system (UMTS) radio access network (UTRAN or E-UTRAN), long term evolution (LTE, known also as E-UTRA), long term evolution advanced (LTE-A), Wireless Local Area Network (WLAN), worldwide interoperability for microwave access (WiMAX), Bluetooth®, personal communications services (PCS) and systems using ultra-wideband (UWB) technology.

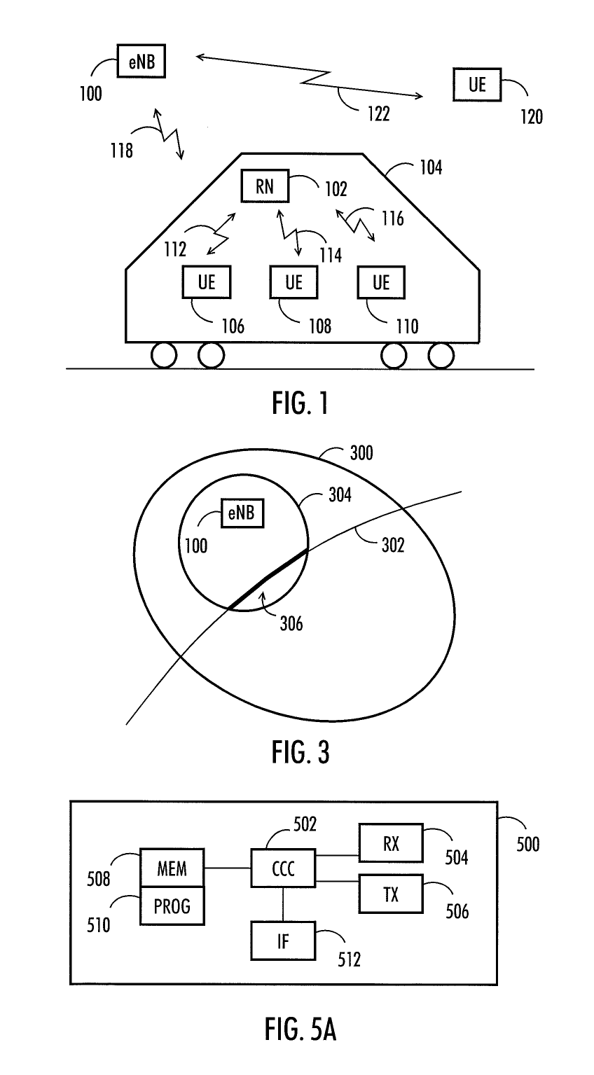

FIG. 1 illustrates an example of a communication environment between user equipment and a telecommunication system. In the illustrated scenario, the relay base station is a mobile (or nomadic) base station installed in a train (or another mobile vehicle) and configured to relay cellular communication links between a fixed cellular network infrastructure and user equipment.

FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures.

The example of FIG. 1 shows a base station or eNode B 100 serving one or more macro cells and a mobile relay base station 102 installed in a mobile vehicle 104. The mobile relay base station is configured to provide network access to user equipment 106, 108, 110 in the moving vehicle. Thus, it serves a moving cell. The user equipment are connected 112, 114, 116 to the mobile relay base station 102. The mobile relay base station 102 is connected 118 to the macro eNodeB. Naturally, the eNodeB 100 may also serve other user equipment 120 having direct connections 122 with the eNodeB. The user equipment refers to a portable computing device. Such computing devices include wireless mobile communication devices operating with or without a subscriber identification module (SIM), including, but not limited to, the following types of devices: mobile phone, smartphone, personal digital assistant (PDA), handset, laptop computer.

It should be appreciated that the eNodeB is also connectable to a core network (CN) of a telecommunication system directly or via a radio network controller (not shown in the Figure). Depending on the system, the counterpart on the CN side can be a mobile services switching centre (MSC), a media gateway (MGW) or a serving GPRS (general packet radio service) support node (SGSN), home node B gateway (HNB-GW), mobility management entity and enhanced packet core gateway (MME/EPC-GW), etc. The communication system is also able to communicate with other networks, such as a public switched telephone network.

The embodiments are not, however, restricted to the system given above as an example but a person skilled in the art may apply the solution to other communication systems provided with the necessary properties.

Typically, in a geographical area of a radio communication system there is provided a plurality of different kinds of radio cells. A cellular radio system may be implemented as a multilayer network including macro-, micro and pico-cells. Each of the cells may be arranged to have a unique identity (such as a cell global Identity (CGI), cell identifier (CID) or physical layer cell identifier (PLCID)) for distinctly identifying the cells.

The mobile relay node 102 has the full functionality of e.g. LTE-A eNode B towards the user equipment 106, 108, 110 but it is attached to the network side using a mobile wireless backhaul.

From the frequency spectrum point of view, there are various alternatives to realize the connections of a mobile relay node.

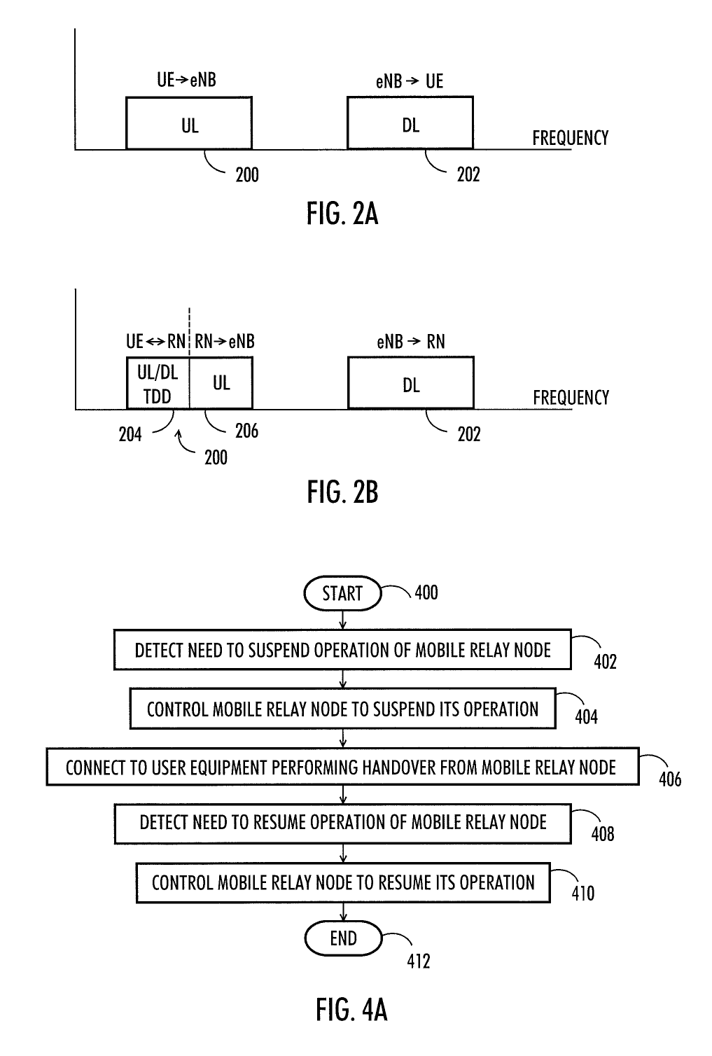

In an embodiment, flexible spectrum usage (FSU) is utilized. FIGS. 2A and 2B illustrate an example. FIG. 2A illustrates frequency allocation for an eNodeB 100. The uplink connections from user equipment 120 to the eNodeB use frequency band 200. The downlink connections from the eNodeB to the user equipment 120 use frequency band 202. FIG. 2B illustrates and example where the mobile relay node 102 is assumed to operate in time division duplex (TDD) mode using a part 204 of uplink bandwidth of the wide-area mobile cellular system for the connections 112, 114, 116 between the user equipment 106, 108, 110 and the mobile relay base station 102. The part 206 of the uplink bandwidth 200 is used for the uplink communication from the mobile relay node to the eNodeB 100. The downlink traffic from the eNodeB to the mobile relay node utilizes the frequency band 202. The resource allocation for the mobile relay node 102 and its cell is then due to the current (or targeted) relaying macro eNodeB 100.

The above arrangement has the advantage that it allows for the operation of the relay node cell not to interfere with the relaying macro cell in the downlink direction and to be more controllable in the uplink direction.

In another embodiment, the mobile relay nodes are operated out-band (in an unlicensed band or as a secondary user of a licensed band, for example) of relaying cellular system to avoid interference with a relaying macro cell. However, in this embodiment the relay cells, operating in an unlicensed band, may suffer severe interference from other moving cells in close vicinity or other devices operated in the same unlicensed band due to uncoordinated resource allocation characteristic of unlicensed bands. The relay cells, as a secondary user of a licensed band, may not be allowed to cause any notable interference to a primary user which may present over a certain area, defined by the radio range of the primary user, wherever along the travelling path of the relay cells. Considering the special FSU arrangement for mobile relay node operation as described the first embodiment above, it is noticed that a mobile relay node may not be suitable to operate in the whole coverage area of the relaying macro cell 100. FIG. 3 illustrates an example. An eNodeB 100 is serving a macro cell 300. A road or a railroad 302 travels through the cell. For example, to avoid severe interference with the relaying eNodeB 100 in uplink direction, the operation of mobile relay node operating in a vehicle travelling on the road 302 may not be allowed in certain exclusion zone 304 that is close to macro eNodeB. Thus, an active mobile relay node needs to be temporarily suspended when it moves into the exclusion zone, and resumed after it passed the zone. During the temporary suspension 306 and fast resumption of the mobile relay node, the mobile users that are connected to the mobile relay node may need to be handed over forth and back between the moving cell and the relaying macro cell.

The same kind of mobile relay node suspension and resumption method, as well as the forth and back handover of the user equipment between the moving cell and the relaying macro cell is needed also if the mobile relay node is operated in unlicensed band and is experiencing severe interference in a certain time period.

Furthermore, some on-the-fly reconfiguration operations of mobile relay node cells may also trigger a need for relay node suspension and resumption.

From the user equipment point of view, the suspension procedure means that the operation of a mobile relay node's cell towards the user equipment is temporarily halted or suspended. The relay node stops serving the user equipment connected to it for a certain period of time. The relay node tries to resume its operation as quick as possible with minimum impacts on the user equipment. The user equipment may be handed over to a macro cell for the duration of the suspension.

From the network point of view, the suspension also means a designated operating state of a mobile relay node. In this state, the relay node may still communicate with the network via the relaying eNB on a backhaul connection. The relay node may still carry out radio measurements and reporting on the backhaul connection. Thus, the relay node and its backhaul connection can be controlled and maintained even when being suspended.

In an embodiment, the suspension procedure has at least the following properties: First, a mobile relay node has certain mobile contexts specific to the suspension state. The context may include suspension state information of the relay node, contexts of the user equipment having been served by the relay node and currently suspended and contexts of the user equipment having been served by the relay node and currently handed over to the relaying eNodeB. The contexts of the user equipment may include only the user equipment identifier information mapped to the suspended relay node, may not be necessary to include the full user equipment context that has been used in relay node. These contexts may be transferred between a source eNodeB and a target eNodeB if handover of the relay node is needed while the relay node is being suspended. Second, configuration parameters specific to the suspension and resumption are needed. The parameters may include designated time intervals, timers, and thresholds for e.g. triggering condition and operation.

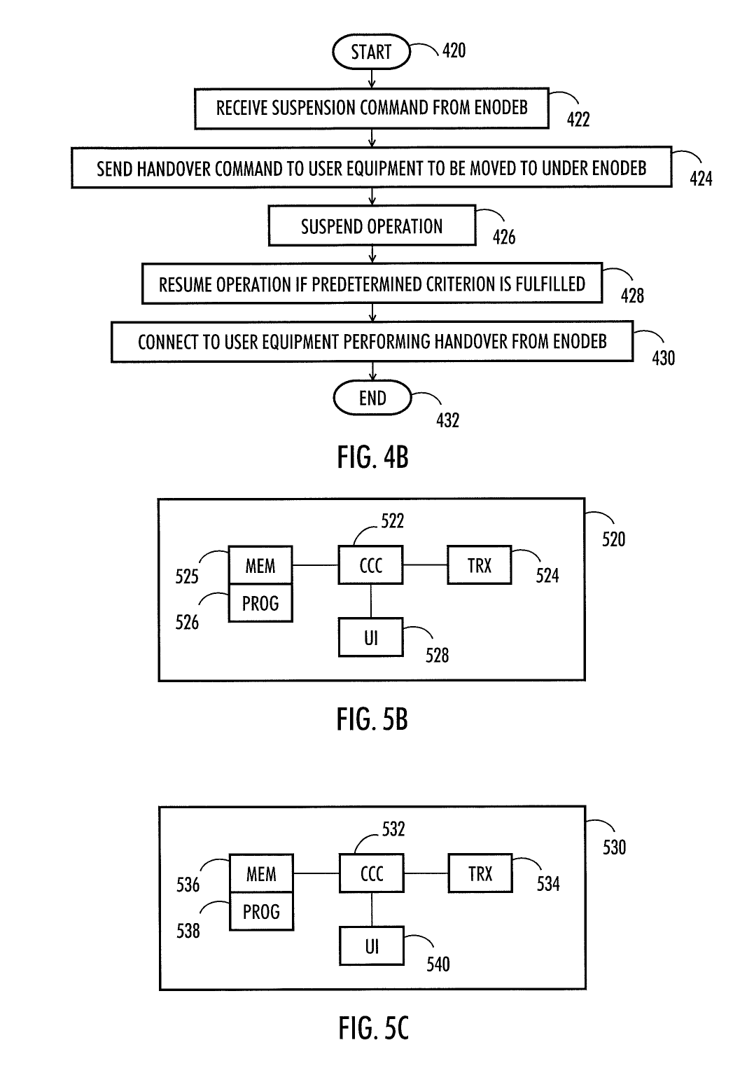

FIGS. 4A and 4B are flowcharts illustrating some embodiments of the invention.

In FIG. 4A, the operation starts in step 400.

In step 402, it is detected on the basis of a predetermined criterion a need to suspend the operation of a mobile relay base station connected to an eNodeB. The predetermined criterion may be measured interference or a need for reconfiguration of the mobile relay node.

In step 404, the mobile relay base station is controlled to suspend its operation.

In step 406, the eNodeB is controlled to connect to the user equipment performing a handover from the mobile relay base station to the eNodeB prior the suspension of the mobile relay base station,

In step 408, it is detected on the basis of a predetermined criterion a need to resume the operation of the mobile relay base station. The predetermined criterion may be that a given time interval has elapsed, measured interference is below a given level, or reconfiguration of the mobile relay node has been finished.

In step 410, the mobile relay base station is controlled to resume its operation.

The process ends in step 412.

In FIG. 4B, the operation starts in step 420.

In step 422, a suspension command is received from an eNodeB.

In step 424, a handover command is sent to user equipment connected to the mobile relay node and to be moved to under the eNodeB,

In step 426, the operation of the mobile relay node is suspended.

In step 428, the operation of the mobile relay node is resumed if a predetermined criterion is fulfilled. The predetermined criterion may be that a given time interval has elapsed or a resume command has been received from an eNodeB. In step 430, the mobile relay node connects to user equipment performing a handover from the eNodeB to the mobile relay node.

The process ends in step 432.

FIG. 5A illustrates a simplified example of an apparatus 500. In some embodiments, the apparatus may be an eNodeB serving at least one macro cell.

It should be understood that the apparatus is depicted herein as an example illustrating some embodiments. It is apparent to a person skilled in the art that the apparatus may also comprise other functions and/or structures. Although the apparatus has been depicted as one entity, different modules and memory may be implemented in one or more physical or logical entities.

The apparatus of the example includes a communication control circuitry 502 configured to control at least part of the operation of the apparatus.

The apparatus further comprises a transmitter 504 and a receiver 506 configured to communicate with other devices, such as user equipment or mobile relay nodes. The transmitter and receiver are operationally connected to the control circuitry 502. They may be connected to an antenna arrangement (not shown).

The transmitter and receiver may be realized as a transceiver comprising transmitting and receiving parts.

The apparatus may further comprise a memory 508 for storing data. Furthermore the memory may store software 510 executable by the control circuitry 502. The memory may be integrated in the control circuitry.

The apparatus may further comprise interface circuitry 512 configured to connect the apparatus to other devices of communication network, for example to core network. The interface may provide a wired or wireless connection to the communication network.

FIG. 5B illustrates a simplified example of a mobile relay node 520.

It should be understood that the apparatus is depicted herein as an example illustrating some embodiments. It is apparent to a person skilled in the art that the mobile relay node may also comprise other functions and/or structures. Although the mobile relay node has been depicted as one entity, different modules and memory may be implemented in one or more physical or logical entities.

The mobile relay node may be implemented in part or in whole as an electronic digital computer, which may comprise a working memory (RAM), a central processing unit (CPU), and a system clock. The CPU may comprise a set of registers, an arithmetic logic unit, and a control unit. The control unit is controlled by a sequence of program instructions transferred to the CPU from the RAM. The control unit may contain a number of microinstructions for basic operations. The electronic digital computer may also have an operating system, which may provide system services to a computer program written with the program instructions.

The mobile relay node of the example includes a communication control circuitry 522 configured to control at least part of the operation of the mobile relay node.

The mobile relay node further comprises a transceiver 524 configured to communicate with other devices, such as user equipment or eNodeB's. The transceiver is operationally connected to the control circuitry 522. It may be connected to an antenna arrangement (not shown).

As one skilled in the art is aware, the transceiver may be realized as a separate transmitter and receiver.

The apparatus may further comprise a memory 525 for storing data. Furthermore the memory may store software 526 executable by the control circuitry 522. The memory may be integrated in the control circuitry.

In an embodiment, the apparatus may further comprise user interface 528 with which the apparatus may be configured by hand if need arises. The user interface may comprise a display and a keypad or keyboard, for example.

FIG. 5C illustrates a simplified example of user equipment 530.

It should be understood that the apparatus is depicted herein as an example illustrating some embodiments. It is apparent to a person skilled in the art that the user equipment may also comprise other functions and/or structures. Although the user equipment has been depicted as one entity, different modules and memory may be implemented in one or more physical or logical entities.

The user equipment may be implemented in part or in whole as an electronic digital computer, which may comprise a working memory (RAM), a central processing unit (CPU), and a system clock. The CPU may comprise a set of registers, an arithmetic logic unit, and a control unit. The control unit is controlled by a sequence of program instructions transferred to the CPU from the RAM. The control unit may contain a number of microinstructions for basic operations. The electronic digital computer may also have an operating system, which may provide system services to a computer program written with the program instructions.

The user equipment of the example includes a communication control circuitry 532 configured to control at least part of the operation of the user equipment.

The user equipment further comprises a transceiver 534 configured to communicate with other devices, such as mobile relay nodes or eNodeB's. The transceiver is operationally connected to the control circuitry 532. It may be connected to an antenna arrangement (not shown).

As one skilled in the art is aware, the transceiver may be realized as a separate transmitter and receiver.

The user equipment may further comprise a memory 536 for storing data required in the operation of the equipment such as connection parameters, user equipment context, mobile relay node and eNodeB contexts. The memory may store user data such as phone numbers and messages. Furthermore the memory may store software 538 executable by the control circuitry 532. The memory may be integrated in the control circuitry. The user equipment may further comprise user interface 540. The user interface may comprise a display, a keypad or keyboard, a microphone and a speaker, for example. The display may be a touch sensitive.

The relaying eNodeB controlled temporary suspension of a mobile relay node may be triggered or initiated by either the relaying eNodeB or the mobile relay node itself.

The relaying eNodeB initiated suspension of mobile relay node may be typically applied in the case the relaying eNodeB and the moving relay node share the same resources like in the example of FIG. 2B. When an active mobile relay node is operated within macro cells of a relaying eNodeB, the communication control circuitry of the eNodeB may control the eNodeB to periodically measure the uplink interference from the mobile relay node. The uplink interference can be measured by the average SIR (signal to interference ratio) for the user equipment which have the uplink resource allocation same as those are allocated for the mobile relay node. Alternatively, the received interference power of the uplink resource blocks that are allocated for the mobile relay node may be used. If the measured uplink interference meets a given pre-defined condition, the relaying macro eNodeB may trigger the temporary suspension of the mobile relay node.

In an embodiment, the communication control circuitry of the relaying eNodeB may also initiate a temporary suspension of a mobile relay node connected to it by, for examples, a need of reconfiguring the mobile relay node cell without notable impacts on active user equipment.

The mobile relay node initiated suspension procedure may be applied when either same resources (FIG. 2B) or different resources (out-band) are used for relaying macro cells and moving cells. When a mobile relay node is activated, it is configured to measure the potential interference to the relaying macro cell in uplink direction if in-band cellular resources are used for moving cells. If out-band cellular resources are used for moving cells the mobile relay node may be configured to measure the interference it is suffering from nearby devices.

The potential interference to the relaying macro cell can be derived from the measurement on cell-specific downlink reference signals, such as RSRP (Reference Signal Received Power). If the measured RSRP is above a given pre-defined threshold (meaning for instance that the mobile relay node is moving too close to the relaying macro eNB), the mobile relay node may trigger the temporary suspension of the relay node by sending an event-triggered interference measurement report to the relaying eNodeB.

The interference that a mobile relay node is suffering may be measured by the average SIR or the received interference power in the operating bandwidth of the mobile relay node. If the measured interference meets a given pre-defined condition, the mobile relay node may trigger the temporary suspension of the relay node by sending an event-triggered interference measurement report to the relaying eNodeB. The measurement report may also be sent periodically.

In an embodiment, the suspension procedure related signaling mechanism can be implemented based on standardized procedures but with certain additions. In an embodiment, the signaling messages between the relaying macro eNodeB and the mobile relay node may be based on LTE X2AP handover preparation procedure messages in terms of user context exchange, radio bearer configuration, etc.; and signaling messages between the mobile relay node and user equipment may be based on LTE RRC (Radio Resource Control) user equipment measurement control and handover messages, but with following additions.

The relaying macro eNodeB may configure or indicate the mobile relay node with, for example, any necessary combination of the following suspension timing parameters.
Suspension Starting Time that defines the time instance (e.g., given in system frame numbers of the relaying cell) that the mobile relay node should suspend its operation and user equipment can start transmission with a macro eNodeB.
Suspension Period that defines the time interval during which handed-over user equipment are served by a macro eNodeB and at the end of which these user equipment may be allowed to get back to the mobile relay node cell autonomously if they detect that the relay node operation is resumed. If not, the next Suspension Period may be taken into use. This parameter may also be used by the eNodeB or the relay node to make interference measurements for triggering the resumption of the relay node after the relay node is suspended. This parameter may be designated in such a manner that it allows sufficient time for the needed detection and measurements. The detection may be based on that the involved user equipment perform certain radio measurements about the relay node resumed and/or that relay node or the eNodeB may implicitly or explicitly indicate the user equipment about the readiness of a possible resumption.
Resumption Threshold that defines the pre-determined interference or pathloss threshold used by a mobile relay node to trigger the resumption of the relay node operation. This is related to the measurement of potential interference due to a relay node moving too close to an eNodeB, as described above in the mobile relay node initiated suspension scheme.
Suspension Termination Period that defines the maximum time period after which a fast resumption of a mobile relay node operation should not be applied any more for the handed-over user equipment and relay node. The user equipment and the relay node will release the corresponding user equipment contexts concerning the relay node. The user equipment remain in the eNodeB macro cell. This parameter may be designated as one equal to or a multiple of Suspension Period.

As an alternative to the above parameters, the eNodeB may send the mobile relay node Suspension Ending Time that defines the time instance when the mobile relay node operation is resumed autonomously. However, before this time instance the relaying macro eNodeB is allowed to explicitly request the relay node to resume and indicate the handed-over user equipment for the resumption of the relay node. This can be considered as an alternative to the option of using Suspension Period coupled with Suspension Termination Period.

Before a mobile relay node suspends its operation, it is configured to command its user equipment, either selective ones or all, to make a synchronous handover to the relaying macro eNodeB. In the handover command message, the timing alignment information of the mobile relay node towards the relaying macro eNodeB may be provided to the user equipment. When the user equipment try to access the relaying macro eNodeB, they can use the timing alignment of the mobile relay node to get uplink synchronization to macro cell and thus skip random access procedure. After the user equipment get downlink synchronization to the macro cell and wait until Suspension Starting Time that is indicated by the mobile relay node in handover command message along with other suspension timing parameters mentioned above, normal communication between the user equipment and the macro eNodeB can be started. During a suspension period, the handed-over user equipment may detect if the suspended relay node has resumed and decide to get back to the mobile relay node at the end of the suspension period in an eNodeB-controllable autonomous fashion.

After a mobile relay node has suspended its operation, it can still connect to the eNodeB like active user equipment. In addition, the mobile relay may store specific parts of the user equipment contexts of all the handed-over user equipment for possible fast resumption. The stored information may comprise user equipment identifications (UE ID) and optional radio bearer contexts that the user equipment were allocated when they were served by the relay node. Meanwhile, the user equipment may keep the same parts of those suspended contexts concerning with the relay node cell as well as the context of the mobile relay node cell (in order for possibly getting back to it autonomously after a suspension period) after user equipment is handed over to a macro cell. Those “previous” contexts can be reused when the user equipment come back to the relay node to ensure a fast and efficient backward handover. The mobile relay node context can also be used by the user equipment to check and detect the availability of the mobile relay node.

Let us next study the macro eNodeB controlled resumption of a mobile relay node where the handed-over user equipment are handed back to the mobile relay node.

The resumption of the operation of a suspended mobile relay node may be triggered and initiated either by a macro eNodeB or by the mobile relay node constrained to the configured suspension parameters such as Suspension Period and Suspension Termination Period mentioned above. When the resumption is triggered by the eNodeB, the resumption may be based on pathloss measurement towards the relay node or the location of relay node, for example. The eNodeB may perform required measurements periodically. When the interference is below a pre-determined level the suspension may be ended. In an embodiment, the eNodeB may monitor the location of the relay node. When the relay node has moved outside a pre-determined area (exclusion zone) the resumption may be triggered. When the resumption is triggered by the mobile relay node, it may be based on the same kind of measurement discussed above in connection with suspension.

In an embodiment, explicit signaling occurs between the relaying macro eNodeB and the suspended mobile relay node when the operation of the mobile relay node is resumed.

In an embodiment, when a need for the resumption has been determined, the communication control circuitry 502 of an eNodeB may be configured to control the transmitter of the eNodeB to send a resume request to the mobile relay base station. The control circuitry may be further configured to control the receiver of the eNodeB to receive a resume response from the mobile relay base station and to receive a resume complete message from the mobile relay base station.

The macro eNodeB may include the resource allocation for mobile relay node communication in the resume request message. The mobile relay node may respond to the resume request message with either a standalone resume response message, or the response may be embedded in a resume complete message. In the resume complete message the mobile relay node may indicate the macro eNodeB a list of the UE IDs of the user equipment previously allocated by and used in macro cell but which make a handover back to the mobile relay node. This allows the macro eNodeB to delete those user equipment contexts and release corresponding resources. To make the mobile relay node aware of an UE ID that is allocated by the macro eNodeB, user equipment can indicate this information to the mobile relay node after it comes back to the moving cell. Alternatively, the mobile relay node may keep a mapping table between the UE IDs used in the macro cell and the moving cell for each set of user equipment.

In an embodiment, no explicit signaling is needed between a macro eNodeB or a mobile relay node and user equipment getting back to the mobile relay node after the mobile relay node is resumed. Instead, the user equipment are configured to check the availability of the mobile relay node in a periodic fashion with an interval defined by a fraction of the configured Suspension Period, for example. The availability check of the mobile relay node may be based on a detected physical cell ID and optionally on some further information broadcasted on a broadcast channel (BCH) by the mobile relay node. If the detected information matches the mobile relay node context retained in the user equipment, the user equipment may assume that the mobile relay node has been resumed and autonomously get back to the moving cell using old user equipment context (e.g. UE ID that was allocated by the mobile relay node).

In an embodiment, the macro eNodeB may explicitly indicate the user equipment which are handed over to the macro cell when the mobile relay node was suspended that the resumption of the relay node is about to occur. This way the user equipment are triggered to perform a handover back to the relay node. In this embodiment, the user equipment do not need to store the old user equipment context previously used in the relay node connection and the context of the moving relay node. Instead, the context information can be indicated to the user equipment by the macro eNodeB in the explicit message to enable more flexible context update if necessary. In an embodiment, if the macro eNodeB did not request the mobile relay node to resume within Suspension Termination Period, the mobile relay node will terminate its operation and delete all the user equipment contexts that were kept when the mobile relay node was suspended. Hereafter, the mobile relay node needs to be activated by a normal reactivation procedure. Therefore a fast resumption procedure may not be utilized anymore. In this case, the user equipment can not detect the availability of the mobile relay node within Suspension Termination Period. This triggers the user equipment to delete the old user equipment context concerning the previous relay node connection. Likewise the user equipment delete the context of the mobile relay node. This is also applied for the user equipment which move away from the coverage of the relay node. This may happen if users get off the vehicle during suspension of mobile relay node, for example. If the eNodeB utilized Suspension Ending parameter when suspending a mobile relay node, the operation of the relay node is resumed at Suspension Ending autonomously without any signaling involvement between the eNodeB and the mobile relay node. In this embodiment, user equipment may autonomously perform handover back to the mobile relay node, as proposed above. In addition, the macro eNodeB may request the mobile relay node to resume at any time instance before Suspension Ending. The resumption of the relay node may be signaled to the user equipment which made a handover to the eNodeB from the relay node at the time of the suspension. The explicit signaling proposed above may be fully applied for this case as well.

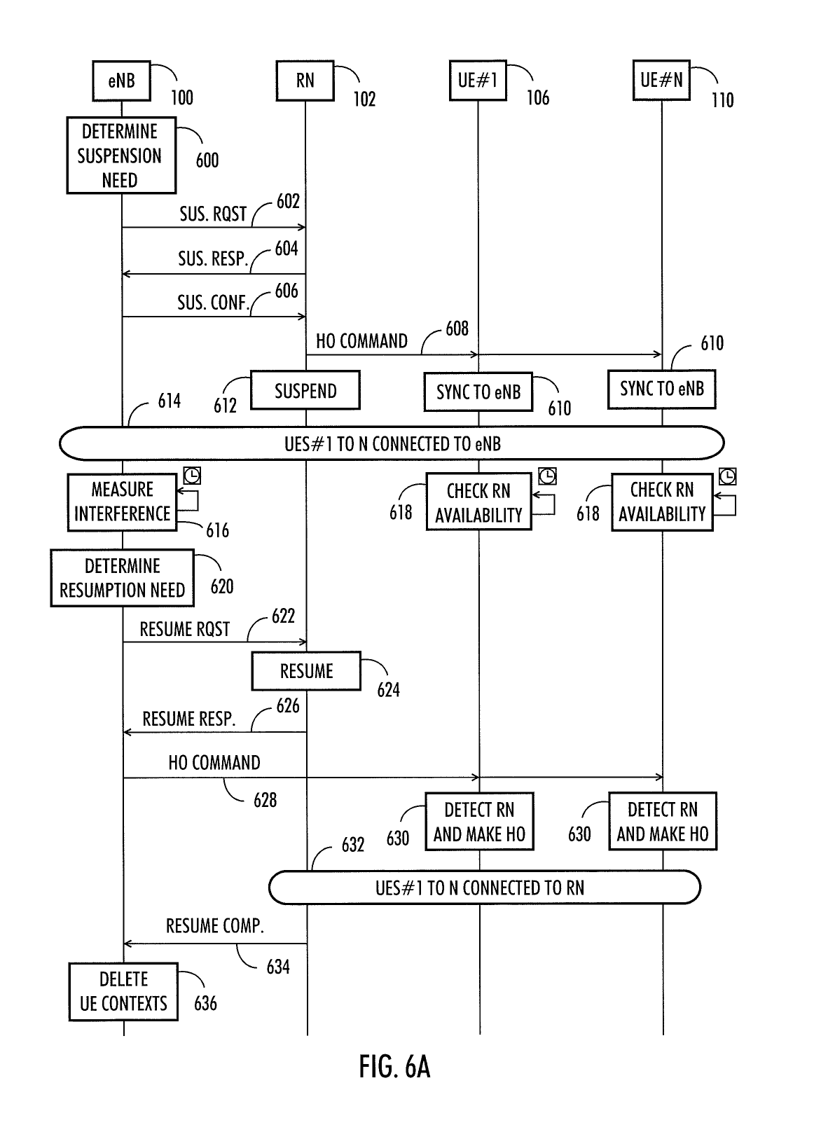

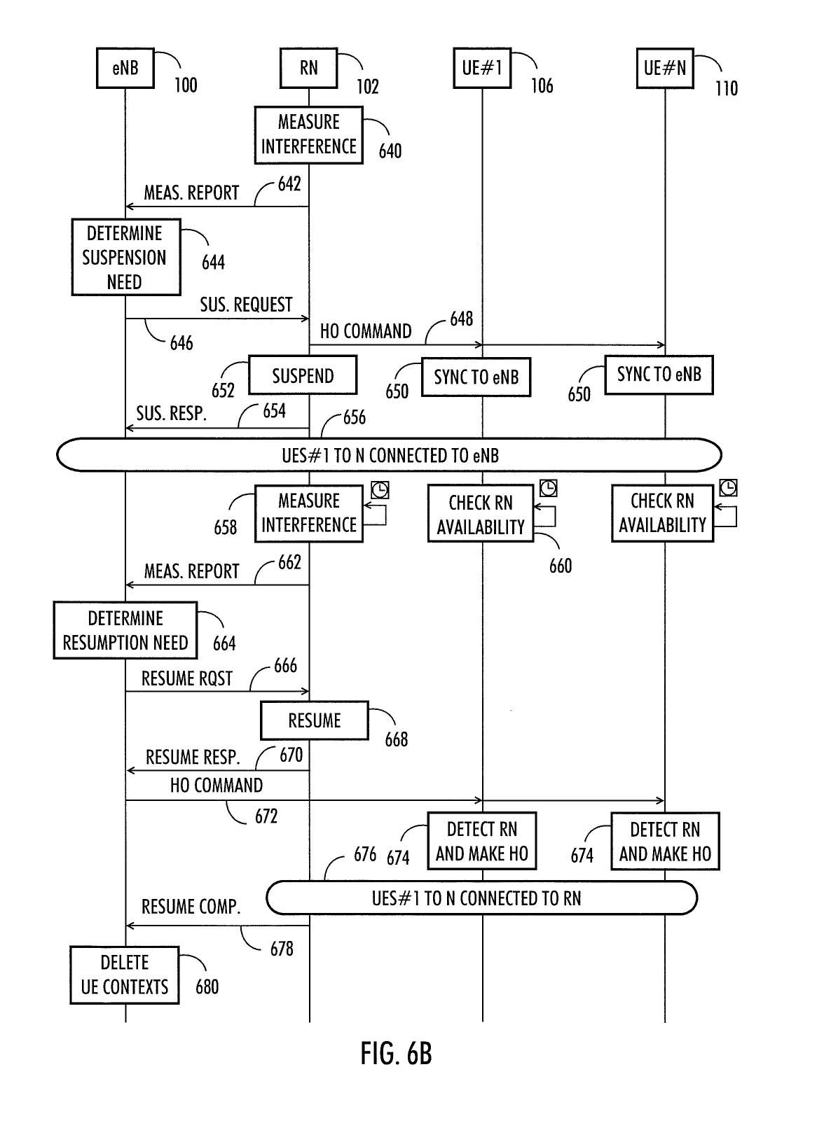

FIG. 6A is a signaling chart illustrating an embodiment of the invention. The chart illustrates an example of a macro eNodeB triggered moving relay node suspension and resumption scheme. The chart illustrates signaling occurring between the eNodeB 100 serving a macro cell, a mobile relay node 102 serving a mobile cell and user equipment 106, 110 originally connected to the mobile relay node 102.

In phase 600, the communication control circuitry of the eNodeB determines on the basis of a predetermined criterion a need to suspend the operation of the mobile relay node 102 connected to the eNodeB. The communication control circuitry may be configured to measure uplink interference level from the mobile relay base station periodically and detect a need for suspension on the basis of the interference level.

The communication control circuitry of the eNodeB 100 sends a suspense request 602 to the mobile relay node 102.

The relay node 102 responds with a suspension response 604, which may comprise information on the user equipment contexts of the user equipment connected to the relay node.

The communication control circuitry of the eNodeB sends a suspension confirm message 606 to the mobile relay node. The message may comprise a set of suspension parameters controlling the initiation, duration and ending of the suspension period, if these parameters have not yet been sent in the suspense request. The parameters comprise Suspension Start Time, Suspension Period, Suspension Termination Period, for example. In addition, the message may comprise information on new user equipment IDs and radio bearer information for the user equipment that are accepted by the eNodeB.

The mobile relay node send a handover command 608 to the user equipment connected to the relay node. The command may comprise timing alignment information of the connection to the eNodeB and suspension parameters the relay node received from the eNodeB.

The user equipment 106, 110 synchronize 610 to the macro cell in downlink and prepare for communication with the eNodeB after Suspension Start Time. The user equipment may keep old user equipment context used in relay node and the context of the relay node.

The mobile relay node suspends 612 its operation at Suspension Start Time. However, it may store the user equipment contexts so that the connections with the user equipment may be set up quickly after resumption. The relay node may be in connection with the eNodeB in the same manner as normal user equipment during suspension.

In phase 614, the user equipment are connected to the eNodeB and transfer data via the eNodeB.

The eNodeB measures 616 relay node periodically during the suspension period interval. Likewise, the user equipment check 618 periodically the availability of the relay node. In phase 620, the communication control circuitry of the eNodeB 100 determines to resume the operation of the mobile relay base station on the basis of the measurements.

The eNodeB is configured to send a resume request 622 to the mobile relay node. The eNodeB may include the resource allocation for mobile relay node communication in the resume request message.

Having received the resume request message the mobile relay node resumes 624 the operation.

The relay node sends a resume response 626 to the eNodeB 100. The message may comprise information on new user equipment contexts that will be used in the mobile relay node and other information.

The eNodeB may send a handover command 628 to corresponding user equipment 106, 110. The message may comprise information on user equipment contexts that will be used in the mobile relay node and the mobile relay node context.

The user equipment detect 630 the resumed relay node and make a handover to the relay node.

In phase 632, user equipment are connected to the mobile relay node 102 and transfer data via the mobile relay node. The mobile relay node transmits a resume complete message 634 to the eNodeB. The message may comprise a list of the UE IDs of the user equipment previously allocated by and used in macro cell but which make a handover back to the mobile relay node.

The eNodeB deletes 636 the contexts of the user equipment on the list received from the relay node.

FIG. 6B is a signaling chart illustrating an embodiment of the invention. The chart illustrates an example of a mobile relay node triggered moving relay node suspension and resumption scheme. The chart illustrates signaling occurring between the eNodeB 100 serving a macro cell, a mobile relay node 102 serving a mobile cell and user equipment 106, 110 originally connected to the mobile relay node 102.

In phase 640, the mobile relay node is configured to measure interference as described above. A measurement report 642 is triggered if the measured interference level exceeds a predetermined level. The report may comprise information on measurement result and contexts of user equipment connected to the relay node.

In phase 644, the communication control circuitry of the eNodeB determines on the basis of the measurement result the need to suspend the operation of the mobile relay base station 102 connected to the eNodeB.

The communication control circuitry of the eNodeB 100 sends a suspense request 646 to the mobile relay node 102. The message may comprise a set of suspension parameters controlling the initiation, duration and ending of the suspension period. The parameters comprise Suspension Start Time, Suspension Period, Suspension Termination Period, for example. In addition, the message may comprise information on new user equipment IDs and radio bearer information for the user equipment that are accepted by the eNodeB.

The mobile relay node send a handover command 648 to the user equipment connected to the relay node. The command may comprise timing alignment information of the connection to the eNodeB and suspension parameters the relay node received from the eNodeB.

The user equipment 106, 110 synchronize 650 to the macro cell in downlink and prepare for communication with the eNodeB after Suspension Start Time. The user equipment may keep old user equipment context in relay node and the context of the relay node.

The mobile relay node suspends 652 its operation at Suspension Start Time. However, it may store the user equipment contexts so that the connections with the user equipment may be set up quickly after resumption. The relay node may be in connection with the eNodeB in the same manner as normal user equipment during suspension.

The mobile relay node sends a suspension response 654 to the eNodeB to indicate that the suspension is complete.

In phase 656, the user equipment are connected to the eNodeB and transfer data via the eNodeB.

The mobile relay node measures 658 interference periodically during the suspension period interval. Likewise, the user equipment check 660 periodically the availability of the relay node.

The mobile relay node sends a measurement report 662 to the eNodeB periodically or event triggered.

In phase 664, the communication control circuitry of the eNodeB 100 determines to resume the operation of the mobile relay base station on the basis of the measurement report. The eNodeB is configured to send a resume request 666 to the mobile relay node. The eNodeB may include the resource allocation for mobile relay node communication in the resume request message.

Having received the resume request message the mobile relay node resumes 668 operation.

The relay node sends a resume response 670 to the eNodeB 100. The message may comprise information on user equipment contexts that will be used in the mobile relay node and other information.

The eNodeB sends a handover command 672 to user equipment 106, 110. The message may comprise information on user equipment contexts that will be used in the mobile relay node and mobile relay node context.

The user equipment detect 674 the resumed relay node and make a handover to the relay node.

In phase 676, user equipment are connected to the mobile relay node 102 and transfer data via the mobile relay node. The mobile relay node transmits a resume complete message 678 to the eNodeB. The message may comprise a list of the UE IDs of the user equipment previously allocated by and used in macro cell) but which make a handover back to the mobile relay node.

The eNodeB deletes 680 the user equipment contexts of the user equipment on the list received from the relay node. The apparatuses of FIGS. 5A, 5B and 5C may be implemented at least in part as an electronic digital computer, which may comprise a working memory (RAM), a central processing unit (CPU), and a system clock. The CPU may comprise a set of registers, an arithmetic logic unit, and a control unit. The control unit is controlled by a sequence of program instructions transferred to the CPU from the RAM. The control unit may contain a number of microinstructions for basic operations. The implementation of microinstructions may vary, depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

The apparatuses of FIGS. 5A, 5B and 5C may be implemented at least in part using at least one chipset or integrated circuit such as ASICs (application-specific integrated circuit).

Embodiments of the invention may be implemented as computer software executable by a processor, or as a combination of software and hardware.

An embodiment provides a computer program embodied on a distribution medium, comprising program instructions which, when loaded into an electronic apparatus, perform the actions of the controller, transmitter, receiver and other units of the apparatuses described earlier.

The computer program may be in source code form, object code form, or in some intermediate form, and it may be stored in some sort of carrier, which may be any entity or device capable of carrying the program. Such carriers include a record medium, computer memory, read-only memory, and software distribution package, for example. Depending on the processing power needed, the computer program may be executed in a single electronic digital computer or it may be distributed amongst a number of computers.

The steps, signaling messages and related functions described above in Figures are in no absolute chronological order, and some of the steps may be performed simultaneously or in an order differing from the given one. Other functions can also be executed between the steps or within the steps and other signaling messages sent between the illustrated messages. Some of the steps or part of the steps can also be left out or replaced by a corresponding step or part of the step. In an embodiment, the invention relates to an apparatus comprising: means for detecting on the basis of a predetermined criterion a need to suspend the operation of a mobile relay base station connected to the apparatus, means for controlling the mobile relay base station to suspend its operation, means for controlling the apparatus to connect to the user equipment performing a handover from the mobile relay base station to the apparatus prior the suspension of the mobile relay base station, means for detecting on the basis of a predetermined criterion a need to resume the operation of the mobile relay base station, and means for controlling the mobile relay base station to resume its operation.

In an embodiment, the invention relates to an apparatus comprising: means for receiving a suspension command from an eNodeB, means for sending a handover command to user equipment connected to the apparatus and to be moved to under the eNodeB, means for suspending the operation of the apparatus, means for resuming the operation of the apparatus if a predetermined criterion is fulfilled, and means for connecting to user equipment performing a handover from the eNodeB to the apparatus.

In an embodiment, the invention relates to an apparatus comprising: means for performing a synchronous handover from a mobile relay base station to an eNodeB when the mobile relay base station is to be suspended temporarily; means for storing user equipment context and mobile relay node context while being connected to the eNodeB; and means for performing a handover back to the mobile relay base station utilizing the stored contexts if the mobile relay node is detected to resume operation.

It will be obvious to a person skilled in the art that, as technology advances, the inventive concept can be implemented in various ways. The invention and its embodiments are not limited to the examples described above but may vary within the scope of the claims.

1. An apparatus comprising:
a communication control circuitry configured to
detect on the basis of a predetermined criterion a need to suspend the operation of a mobile relay base station connected to the apparatus,
control the mobile relay base station to suspend its operation,
control the apparatus to connect to the user equipment performing a handover from the mobile relay base station to the apparatus prior the suspension of the mobile relay base station,
detect on the basis of a predetermined criterion a need to resume the operation of the mobile relay base station, and control the mobile relay base station to resume its operation.

2. The apparatus of claim 1, wherein the communication control circuitry is further configured to
control a transmitter to send a suspend request to the mobile relay base station,
control a transmitter transmit suspension parameters to the mobile relay base station
determine on the basis of a predetermined criterion to resume the operation of the mobile relay base station,
control a transmitter to send a resume request to the mobile relay base station,
control a receiver to receive a resume response from the mobile relay base station, and
control a receiver to receive a resume complete message from the mobile relay base station.

3. The apparatus of claim 1, wherein the communication control circuitry is further configured to control a transmitter to send to the mobile relay base station at least one of following:
the time instance the mobile relay base station should suspense its operation,
the minimum time period the suspension is to be in effect, a threshold level defining the downlink interference or path loss level used by the mobile relay base station to trigger a request to end suspension,
the maximum time period of suspension, after which a resume operation of user equipment connections to the mobile relay base station is not to be attempted.

4. The apparatus of claim 1, wherein the communication control circuitry is further configured to control a transmitter to send to the mobile relay base station the time instance the mobile relay base station should resume its operation.

5. The apparatus of claim 1, wherein the communication control circuitry is further configured to measure uplink interference level from the mobile relay base station and detect a need for suspension or resumption on the basis of the interference level.

6. The apparatus of claim 1, wherein the communication control circuitry is further configured to control a receiver to receive from the mobile relay base station information on interference level experienced by the mobile relay base station and detect a need for suspension or resumption on the basis of the received interference level.

7. The apparatus of claim 1, wherein the communication control circuitry is further configured to determine a need to reconfigure the mobile relay base station and detect a need for suspension or resumption on the basis of the determination.

8. (canceled)

9. (canceled)

10. (canceled)

11. (canceled)

12. (canceled)

13. An apparatus comprising:
a communication control circuitry configured to
receive a suspension command from an eNodeB connected to the apparatus,
send a handover command to user equipment connected to the apparatus and to be moved to under the eNodeB,
suspend the operation of the apparatus,
resume the operation of the apparatus if a predetermined criterion is fulfilled, and
connect to user equipment performing a handover from the eNodeB to the apparatus.

14. The apparatus of claim 13, wherein the communication control circuitry is further configured to:
receive suspension parameters from the eNodeB,
suspend the operation of the apparatus on the basis of the received parameters,
receive a resume request from the eNodeB and resume the operation of the apparatus,
send a resume complete message to the eNodeB.

15. The apparatus of claim 14, wherein the communication control circuitry is further configured to receive from the eNodeB and send to the user equipment at least one of following:
the time instance the apparatus should suspense its operation,
the minimum time period the suspension is to be in effect, a threshold level defining the downlink interference or path loss level used by the apparatus to trigger a request to end suspension,
the maximum time period of suspension, after which a resume operation of user equipment connections to the apparatus is not to be attempted.

16. The apparatus of claim 13, wherein the communication control circuitry is further configured to
receive from the eNodeB and send to the user equipment the time instance the apparatus should resume its operation, and resume the operation of the apparatus at the time instance without a specific resume command from the eNodeB.

17. The apparatus of claim 13, wherein the communication control circuitry is while the apparatus is suspended further configured to store the user equipment contexts of the user equipment which were connected to the apparatus prior suspending.

18. (canceled)

19. (canceled)

20. (canceled)

21. (canceled)

22. (canceled)

23. (canceled)

24. An apparatus comprising:
a communication control circuitry configured to control the apparatus to
perform a synchronous handover from a mobile relay base station to an eNodeB when the mobile relay base station the apparatus is connected to is to be suspended temporarily;
store user equipment context and mobile relay node context while being connected to the eNodeB; and
perform a handover back to the mobile relay base station utilizing the stored contexts if the mobile relay node is detected to resume operation.

25. The apparatus of claim 24, wherein the communication control circuitry further configured to detect that the mobile relay node has resumed operation; and perform a handover to the relay node autonomously.

26. The apparatus of claim 24, wherein the communication control circuitry further configured to perform a handover to the relay node on the basis of a command received from the eNodeB.

27. The apparatus of claim 24, wherein the communication control circuitry further configured to delete the stored UE context and mobile relay node context if the mobile relay node has not been detected to resume operation within a predetermined time period.

28. The apparatus of claim 24, wherein the communication control circuitry is further configured to receive from the mobile relay node at least one of following: the time instance the mobile relay node should suspense its operation,
the minimum time period the suspension is to be in effect, the maximum time period of suspension, after which the apparatus should not attempt to handover back to the mobile relay node,
the time instance the mobile relay node should resume its operation and the apparatus can handover back to the mobile relay node autonomously, and
uplink timing alignment information of the mobile relay node towards the eNodeB.

29. A method comprising:
detecting on the basis of a predetermined criterion a need to suspend the operation of a mobile relay base station,
controlling the mobile relay base station to suspend its operation,
connecting to the user equipment performing a handover from the mobile relay base station prior the suspension of the mobile relay base station,
detecting on the basis of a predetermined criterion a need to resume the operation of the mobile relay base station, and controlling the mobile relay base station to resume its operation.

30. (canceled)

31. (canceled)

32. (canceled)

33. (canceled)

34. (canceled)

35. (canceled)

36. (canceled)

37. (canceled)

38. (canceled)

39. A method in an apparatus, comprising:
receiving a suspension command from an eNodeB,
sending a handover command to user equipment connected to the apparatus and to be moved to under the eNodeB,
suspending the operation of the apparatus,
resuming the operation of the apparatus if a predetermined criterion is fulfilled, and connecting to user equipment performing a handover from the eNodeB to the apparatus.

40. (canceled)

41. (canceled)

42. (canceled)

43. (canceled)

44. (canceled)

45. (canceled)

46. (canceled)

47. (canceled)

48. A method comprising:
performing a synchronous handover from a mobile relay base station to an eNodeB when the mobile relay base station is to be suspended temporarily;
storing user equipment context and mobile relay node context while being connected to the eNodeB; and
performing a handover back to the mobile relay base station utilizing the stored contexts if the mobile relay node is detected to resume operation.

49. (canceled)

50. (canceled)

51. (canceled)
